(19) United States
(12) Patent Application Publication
(10) Pub. No.: US 2022/0063294 A1
(43) Pub. Date: Mar. 3, 2022

(54) LINER-LESS LABEL PRINTER SYSTEM AND METHOD

(71) Applicant: Toshiba TEC Kabushiki Kaisha, Shinagawa-ku (JP)

(72) Inventors: William M. CONNORS, Lexington, KY (US); Donn D. BRYANT, Lexington, KY (US); Michael W. LAWRENCE, Lexington, KY (US); George N. WOOLCOTT, Lancaster, KY (US)

(21) Appl. No.: 17/007,848

(22) Filed: Aug. 31, 2020

(51) Int. Cl. B41J 3/407; B41J 11/00; B41J 13/02; B65C 9/46; B65C 9/18; B65C 9/42; B65H 5/06; B65H 7/14

(52) U.S. Cl. CPC B41J 3/4075; B41J 11/0095; B41J 13/02; B65C 9/46; B65H 2401/10; B65C 9/42; B65H 5/062; B65H 7/14; B65C 9/1892

(57) ABSTRACT

A pre-feed system and method for a liner-less label printer includes a drive roll that is configured to peel liner-less labels from a reel and pass the labels to an in-line label printer at a consistent rate. An idler roll disposed in proximity to the drive roll creates a nip for pulling labels from the reel. The idler roll is comprised of silicone which prevents the adhesive side of the liner-less label from sticking. A print controller monitors a non-contact reflective object sensor disposed in proximity to the path of the liner-less labels between the drive roll and the in-line printer. The print controller adjusts the speed of the drive roll to maintain a consistent rate for labels entering the print feed of the in-line label printer and reduces the amount of force required to feed labels into the printer.

### TECHNICAL FIELD

This application relates generally to a label printing system and more particularly to a printer feed mechanism for printing liner-less labels.

### BACKGROUND

Label printers typically print indicia, such as mailing addresses, onto a label that has adhesive on one side. The adhesive is generally covered with a release paper, or liner, that is removed prior to the label being placed onto the desired object, such as a letter or a box for shipping. These labels requires a person, or mechanism, to remove the release paper which is then discarded resulting in waste that must be disposed of appropriately. Alternatively, a clear plastic sleeve can be configured to accept a printed paper insert, however these sleeves also include a release paper that covers the adhesive portion that must be removed and discarded.

### BRIEF DESCRIPTION OF THE DRAWINGS

Various embodiments will become better understood with regard to the following description, appended claims and accompanying drawings wherein:

FIG. 1A is a first view of an example embodiment of a label printer for liner-less labels;

FIG. 1B is a second view of an example embodiment of a label printer for liner-less labels;

FIG. 2 is a flowchart of example operations of a liner-less label printer; and

FIG. 3 is an example embodiment of a digital device such as a controller for a printer system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Existing label feed systems for printers generally accommodate labels that include release paper or liners that cover adhesive on one side of the labels. After printing such a label, the release paper or liner is removed and discarded. By printing onto a liner-less label, waste associated with release paper or liners can be eliminated, making liner-less label printers more environmentally friendly. Liner-less label printers also reduce extraneous costs associated with disposing of discarded release paper and liners, including labor costs and disposal costs.

A liner-less label can include a single sheet with a designated area on the front side for a customer's shipping address. A liner-less label can also include an adhesive area around the periphery of the back side of the label with a designated print area in the center for printing shipping and customer invoice information. In embodiments, the labels are received as a continuous form on a reel containing a plurality of labels. Liner-less labels on a reel have exposed adhesive which sticks to other labels and can generate relatively high forces on the feed mechanisms that are required to both peel labels off the reel and reliably pass those labels at a consistent speed across the print mechanism. Forces on the feed mechanism may be inconsistent as the labels are peeled off and released from the reel. Inconsistent or high forces on printer feed mechanisms can cause misfeeds or paper jams, and can reduce the quality of printing on the labels if the labels are not fed at a consistent rate across the print mechanism.

Example embodiments of the subject application include a pre-feed mechanism configured to peel continuous form labels off of the reel and present them to the feed mechanism associated with a print mechanism at a consistent rate with a lower force than required to peel the labels off the reel, a printer feed mechanism configured to reliably pass labels over a print mechanism, a print mechanism configured to print on one or both sides of a liner-less label from the reel, and a finisher mechanism configured to cut individual labels to size after printing.

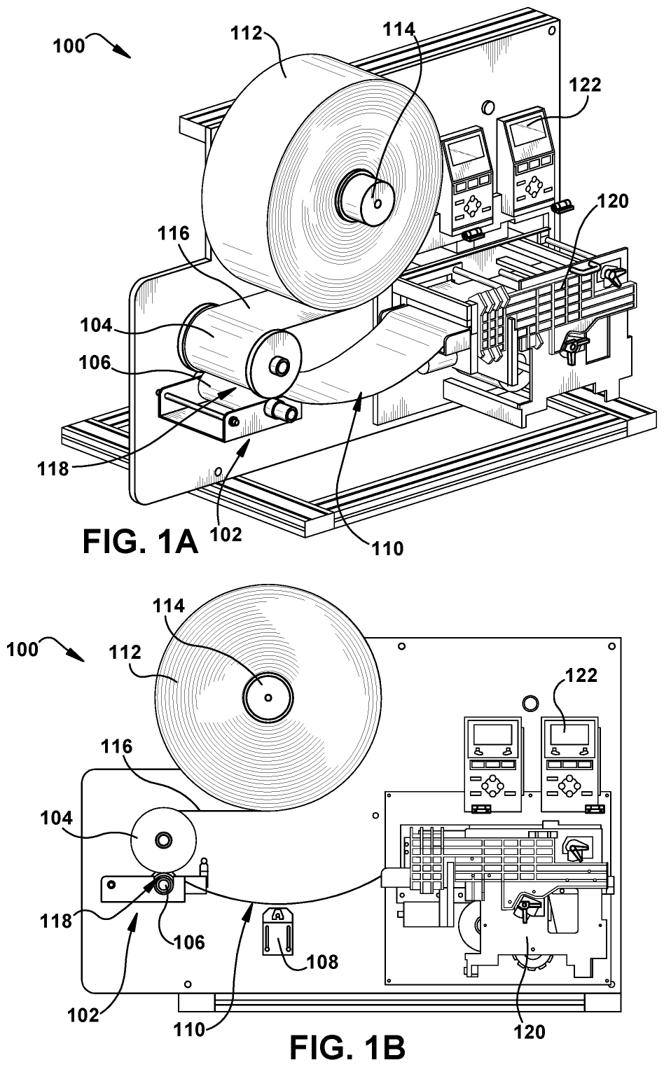

In accordance with the subject application, FIGS. 1A and 1B illustrate an example embodiment of a liner-less print system 100. The liner-less print system 100 includes a pre-feed mechanism 102 comprising a rubber, powered drive roll 104, a silicone rubber idler roll 106, and a non-contact reflective object sensor 108. A reel of liner-less labels 112 is mounted on a rotatable spindle 114. Liner-less labels 116 from the reel 112 are threaded through the nip 118 between the drive roll 104 and the idler roll 106. The drive roll 104 is comprised of rubber or another similar material configured to contact the printable top surface of the liner-less labels 116. The idler roll 106 advantageously is comprised of silicone or another similar material configured to contact the bottom surface of the liner-less label 116 without adhering to or sticking to the adhesive material on the bottom surface of the liner-less label 116.

The drive roll 104 and idler roll 106 pass the liner-less labels 116 to the in-line printer 120. A non-contact reflective object sensor 108 monitors the amount of slack 110 in the liner-less labels 116 in the path between the pre-feed mechanism 102 and the in-line printer 120. The liner-less labels 116 are pulled into the in-line printer 120 at a consistent rate, indicia are printed on one or both sides of the liner-less labels 116, and the label is cut to size by an associated finisher in the in-line printer 120.

In operation, the drive roll 104 is rotated by a print controller 122 to pull liner-less labels 116 from the reel 112 into the nip 118 at approximately the same rate that the liner-less labels 116 are consumed by the in-line printer 120. The print controller 122 monitors the sensor 108 and maintains the proper amount of slack 110 in the liner-less labels 116 that are passed to the in-line printer 120. The pre-feed mechanism 102 advantageously pulls the liner-less labels 116 from the reel 112 and presents them to the input queue of the in-line printer 120 such that a low and consistent force is required by the in-line printer 120 to pull the liner-less labels 116 into the in-line printer 120 for printing and sizing. This low and consistent force advantageously not only reduces misfeeds and paper jams, but also improves the quality of printing on the liner-less labels 116 which are fed at a more consistent rate across the printer mechanism.

The liner-less labels 116 can include a printable top surface configured to accept address indicia associated with a shipping label and a bottom surface that includes adhesive. In embodiments, the adhesive is disposed over only a certain portion of the bottom surface, for example around the edges, leaving a second printable area for accepting additional printed indicia such as invoice information for the end customer. In these embodiments, the consumer can remove the label from a received shipment to view the printed indicia on the bottom surface of a liner-less label 116.

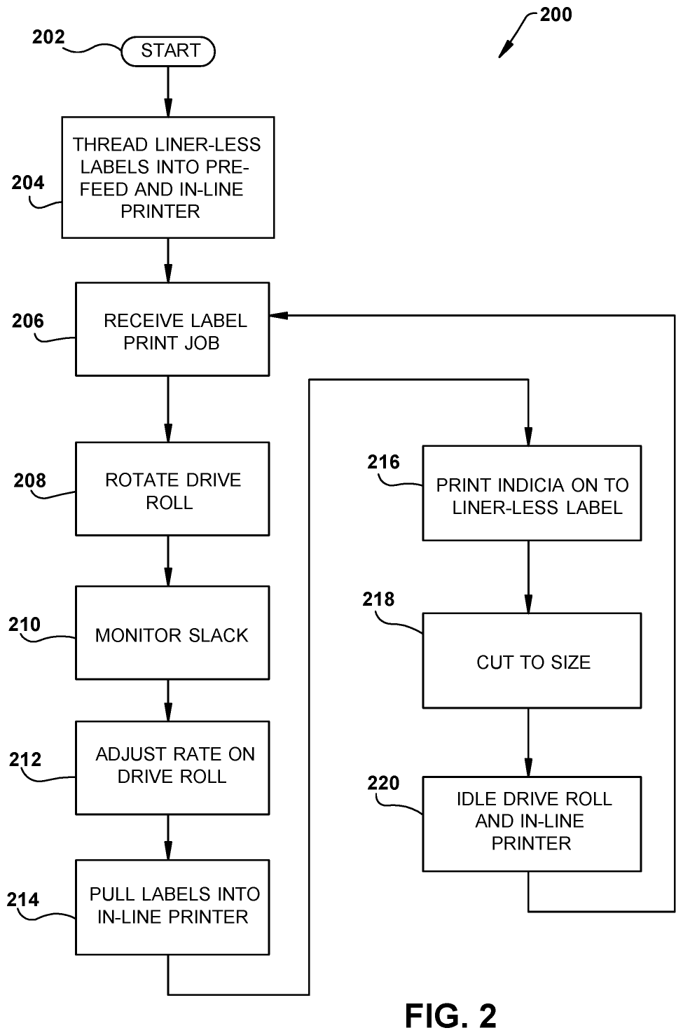

Turning now to FIG. 2, illustrated is a flowchart 200 of example operations of a liner-less label printer. Operation commences at start block 202 and proceeds to block 204 where liner-less labels from a reel of labels are threaded through the nip between a drive roll and idler roll in the pre-feed mechanism, passed over a non-contact sensor, and inserted into the feed mechanism of the in-line printer. At block 206, the liner-less label printer receives a print job for a label, such as a shipping label. At block 208 the print controller rotates the drive roll with a first, high torque to pull the liner-less labels from the reel into the nip between the drive roll and idler roll. At block 210 the print controller sensor monitors sensor to determine the slack in the liner-less labels between the pre-feed mechanism and the in-line printer. At block 212 the print controller adjusts the rate of the drive roller in accordance to the monitored sensor to maintain the determined amount of slack in the liner-less labels. At block 214 the print controller activates the feed mechanism of the in-line printer which pulls the liner-less labels at a second, lower torque to pull the liner-less labels into the in-line printer for printing. At block 216 the in-line printer prints indicia on one or both sides of the liner-less label. Note that the operations of blocks 206 through 216 can be performed essentially simultaneously or in sequence as would be appreciated by one of skill in the art. At block 218 a finisher mechanism associated with the in-line printer cuts the liner-less label to size and ejects the label from the in-line printer. At block 220, the drive roll and in-line printer are idled and operation returns to block 206 to wait for the next label to be printed.

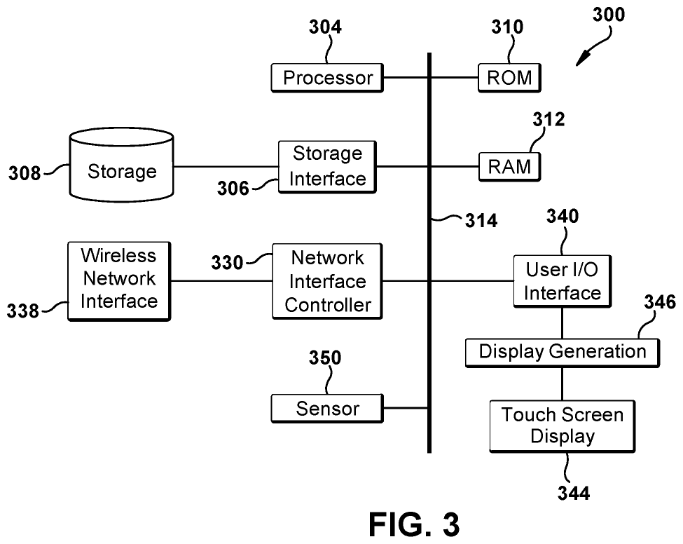

Turning now to FIG. 3, illustrated is an example of a digital device system 300 suitably comprising print controller 132 of FIGS. 1A and 1B. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to a print server is via a data network, such as a local area network (LAN), a wide area network (WAN), which may comprise the Internet, or any suitable combination thereof. A digital data connection is also suitably directly with a print server, such as via Bluetooth, optical data transfer, Wi-Fi direct, or the like.

Processor 304 is also in data communication with a user input/output (I/O) interface 340 which provides data communication with user peripherals, such as touch screen display 344 via display generator 346, as well as keyboards, control buttons, mice, track balls, touch screens, or the like. Processor 304 is also in data communication with sensor 350, suitably comprised of non-contact reflective object sensor for sensing slack in a continuous ribbon of unprinted labels. It will be understood that functional units are suitably comprised of intelligent units, including any suitable hardware or software platform.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A liner-less label printer, comprising:
an in-line printer configured to
receive a liner-less label, and
print indicia on at least one surface of the liner-less label;
a drive roll configured to provide liner-less labels to the in-line printer at a consistent rate; and
an idler roll disposed proximate to the drive roll and configured to receive the liner-less labels into a nip between the drive roll and idler roll.

2. The liner-less label printer of claim 1, further comprising:
a sensor configured to monitor slack in the liner-less labels between the drive roll and the in-line printer.

3. The liner-less label printer of claim 2, further comprising:
a print controller configured to monitor the sensor and adjust operation of the drive roll to maintain the consistent rate.

4. The liner-less label printer of claim 1, further comprising:
a rotatable spindle configured to accept a reel having a plurality of liner-less labels.

5. The liner-less label printer of claim 4, wherein the drive roll is configured to peel the liner-less labels from the reel at a first torque at an inconsistent rate and deliver the liner-less labels to the in-line printer at a consistent rate,
wherein the drive roll allows a second lower torque to be used by a print feed associated with the in-line printer.

6. The liner-less label printer of claim 4, wherein the liner-less labels comprise a first surface configured to accept first printed indicia from the in-line printer and a second surface that includes a first adhesive portion and a second non-adhesive portion configured to accept second printed indicia from the in-line printer.

7. The liner-less label printer of claim 1, wherein the drive roll is comprised of rubber.

8. The liner-less label printer of claim 1, wherein the idler roll is configured to contact a surface of the liner-less labels that includes an adhesive without adhering to the adhesive.

9. The liner-less label printer of claim 8, wherein the idler roll is comprised of silicone.

10. The liner-less label printer of claim 1, wherein the sensor is a non-contact reflective object sensor.

11. A method, comprising:
receiving indicia to be printed onto a liner-less label;
activating a pre-feed drive roller configured to peel liner-less labels from a reel and deliver the liner-less labels to an in-line printer at a consistent rate;
receiving, by the in-line printer, a liner-less label; and
printing, by the in-line printer, the received indicia onto the liner-less label.

12. The method of claim 11, further comprising:
sensing, via a sensor disposed between the drive roller and the in-line printer, an amount of slack in the liner-less labels being delivered to the in-line printer.

13. The method of claim 12, further comprising:
adjusting, in response to the sensed amount of slack by the sensor, the rate of rotation of the drive roller to maintain the consistent rate.

14. The method of claim 12, wherein the sensor is a non-contact reflective object sensor.

15. The method of claim 11, further comprising:
threading the liner-less labels from a reel, through a nip between the drive roller and an idler roller, and into a print feed of the in-line printer.

16. The method of claim 15, wherein the drive roller is comprised of rubber, and wherein the idler roller is configured to contact an adhesive surface of the liner-less labels without adhering to the adhesive.

17. The method of claim 16, wherein the idler roller is comprised of silicone.

18. A pre-feed system for an in-line printer, comprising:
a drive roll configured to peel a plurality of liner-less labels from a reel of labels and provide the labels to the in-line printer at a consistent rate; and
an idler roll disposed proximate to the drive roll and configured to receive the liner-less labels into a nip between the drive roll and idler roll.

19. The pre-feed system of claim 18, further comprising:
a non-contact reflective object sensor configured to monitor slack in the liner-less labels between the drive roll and the in-line printer; and
a print controller configured to monitor the sensor and adjust operation of the drive roll to maintain the consistent rate.

20. The pre-feed system of claim 18, wherein the liner-less labels comprise a first surface configured to accept printed indicia from the in-line printer and a second surface that includes an adhesive, and wherein the idler roll is configured to contact the second surface of the liner-less label without adhering to the adhesive.
